(19) United States
(12) Patent Application Publication
(10) Pub. No.: US 2008/0137200 A1
(43) Pub. Date: Jun. 12, 2008

(54) Optical plate having three layers and backlight module with same

(75) Inventors: Tung-Ming Hsu, Tu-cheng (TW); Shao-Han Chang, Tu-cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI Precision Industry CO., LTD., Tu-Cheng City (TW)

(21) Appl. No.: 11/716,323

(22) Filed: Mar. 9, 2007

(30) Foreign Application Priority Data
Dec. 8, 2006 (CN) 200610201261.5

(51) Int. Cl. G02B 5/02

(52) U.S. Cl. 359/599; 362/620

(57) ABSTRACT

An exemplary optical plate (20) includes a first transparent layer (21), a second transparent layer (23) and a light diffusion layer (22). The light diffusion layer, the first and second transparent layers are integrally formed, with the first transparent layer and the second transparent layer in immediate contact with the light diffusion layer. The light diffusion layer includes a transparent matrix resin (221) and a plurality of diffusion particles (222) dispersed in the transparent matrix resin. The first transparent layer includes a plurality of conical frustum protrusions (211) at an outer surface thereof that is distalmost from the second transparent layer. The second transparent layer includes a plurality of spherical depressions (231) at an outer surface thereof that is distalmost from the first transparent layer. A direct type backlight module using the optical plate is also provided.

### CROSS-REFERENCE TO RELATED APPLICATIONS

This application is related to nine copending U.S. patent applications, which are: application Ser. No. 11/620,951 filed on Jan. 8, 2007, and entitled “OPTICAL PLATE HAVING THREE LAYERS”; application Ser. No. 11/620,958, filed on Jan. 8, 2007, and entitled “OPTICAL PLATE HAVING THREE LAYERS AND MICRO PROTRUSIONS”; application Ser. No. 11/623,302, filed on Jan. 5, 2007, and entitled “OPTICAL PLATE HAVING THREE LAYERS”; application Ser. No. 11/623,303, filed on Jan. 15, 2007, and entitled “OPTICAL PLATE HAVING THREE LAYERS AND BACKLIGHT MODULE WITH SAME”; application Ser. No. 11/627,579, filed on Jan. 26, 2007, and entitled “OPTICAL PLATE HAVING THREE LAYERS”; application Ser. No. [to be advised], Attorney Docket No. US12497, and entitled “OPTICAL PLATE HAVING THREE LAYERS AND BACKLIGHT MODULE WITH SAME”; application Ser. No. [to be advised], Attorney Docket No. US12498, and entitled “OPTICAL PLATE HAVING THREE LAYERS AND BACKLIGHT MODULE WITH SAME”; application Ser. No. [to be advised], Attorney Docket No. US12515, and entitled “OPTICAL PLATE HAVING THREE LAYERS AND BACKLIGHT MODULE WITH SAME”; application Ser. No. [to be advised], Attorney Docket No. US12896, and entitled “OPTICAL PLATE HAVING THREE LAYERS AND BACKLIGHT MODULE WITH SAME”. In all these copending applications, the inventor is Tung-Ming Hsu et al. All of the copending applications have the same assignee as the present application. The disclosures of the above identified applications are incorporated herein by reference.

### BACKGROUND OF THE INVENTION

1. Field of the Invention

The present invention relates to an optical plate for use in, for example, a backlight module, the backlight module typically being employed in a liquid crystal display (LCD).

2. Discussion of the Related Art

The lightness and slimness of LCD panels make them suitable for use in a wide variety of electronic devices such as personal digital assistants (PDAs), mobile phones, portable personal computers, and other electronic appliances. Liquid crystal is a substance that does not itself emit light. Rather, the liquid crystal relies on receiving light from a light source in order to display data and images. In the case of a typical LCD panel, a backlight module powered by electricity supplies the needed light.

FIG. 9 is an exploded, side cross-sectional view of a typical direct type backlight module 100 employing a typical optical diffusion plate. The backlight module 100 includes a housing 11, a plurality of lamps 12 for emitting light disposed above a base of the housing 11, and a light diffusion plate 13 and a prism sheet 14 stacked on top of the housing 11 in that order. Inner walls of the housing 11 are configured for reflecting received light towards the light diffusion plate 13. The light diffusion plate 13 includes a plurality of dispersion particles therein. The dispersion particles are configured for scattering light, and thereby enhancing the uniformity of light output from the light diffusion plate 13. By scattering the light, the light diffusion plate 13 can correct what might otherwise be a narrow viewing angle experienced by a user of a corresponding LCD panel. The prism sheet 14 includes a plurality of V-shaped structures at a top thereof.

In use, light emitting from the lamps 12 enters the prism sheet 14 after being scattered by the light diffusion plate 13. The light is refracted in the prism sheet 14 and concentrated by the V-shaped structures so as to increase brightness of light illumination, and the light finally propagates into the LCD panel (not shown) disposed above the prism sheet 14. Although the brightness may be improved by the V-shaped structures, the viewing angle may be narrowed. In addition, even though the light diffusion plate 13 and the prism sheet 14 abut each other, a plurality of air pockets still exists at the boundary between them. When the backlight module 100 is in use, light passes through the air pockets, and some of the light undergoes back reflection at the air pockets. As a result, the light energy utilization ratio of the backlight module 100 is reduced.

Therefore, a new optical means is desired in order to overcome the above-described shortcomings.

### SUMMARY

An optical plate includes a first transparent layer, a second transparent layer and a light diffusion layer. The light diffusion layer, the first and second transparent layers are integrally formed, with the first transparent layer and the second transparent layer in immediate contact with the light diffusion layer. The light diffusion layer includes a transparent matrix resin and a plurality of diffusion particles dispersed in the transparent matrix resin. The first transparent layer includes a plurality of conical frustum protrusions at an outer surface thereof that is distalmost from the second transparent layer. The second transparent layer includes a plurality of spherical depressions at an outer surface thereof that is distalmost from the first transparent layer.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and backlight module. Moreover, in the drawings, like reference numerals designate corresponding parts throughout the several views, and all the views are schematic.

FIG. 1 is an isometric view of an optical plate in accordance with a first embodiment of the present invention, as seen from a bottom aspect.

FIG. 2 is an isometric view of the optical plate of FIG. 1, as seen from a top aspect.

FIG. 3 is a side cross-sectional view of the optical plate of FIG. 2, taken along line III-III thereof.

FIG. 4 is a top plan view of the optical plate of FIG. 2.

FIG. 5 is an exploded, side cross-sectional view of a direct type backlight module in accordance with a second embodiment of the present invention, the backlight module including the optical plate shown in FIG. 3.

FIG. 6 is a top plan view of an optical plate in accordance with a third embodiment of the present invention.

FIG. 7 is a top plan view of an optical plate in accordance with a fourth embodiment of the present invention.

FIG. 8 is a side cross-sectional view of an optical plate in accordance with a fifth embodiment of the present invention, showing a nonplanar interface between a first transparent layer and a light diffusion layer thereof.

FIG. 9 is a partly exploded, side cross-sectional view of a conventional backlight module.

### DETAILED DESCRIPTION OF THE EMBODIMENTS

Reference will now be made to the drawings to describe preferred embodiments of the present optical plate and backlight module, in detail.

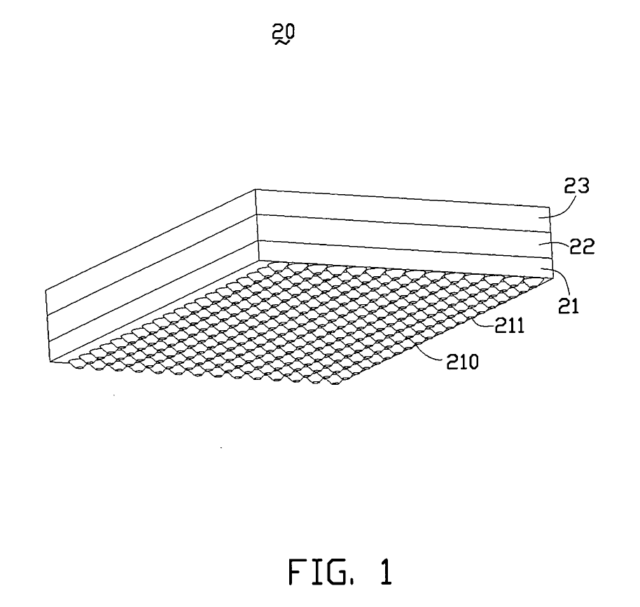

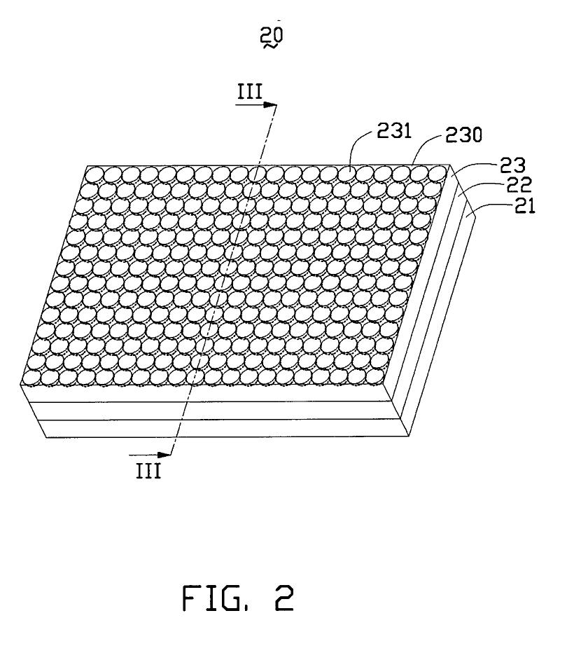

Referring to FIGS. 1 and 2, an optical plate 20 according to a first embodiment of the present invention is shown. The optical plate 20 includes a first transparent layer 21, a light diffusion layer 22, and a second transparent layer 23. The first transparent layer 21, the light diffusion layer 22, and the second transparent layer 23 are integrally formed, with the light diffusion layer 22 between the first and second transparent layers 21, 23. The first transparent layer 21 and the light diffusion layer 22 are in immediate contact with each other at a first common interface. Similarly, the second transparent layer 23 and the light diffusion layer 22 are in immediate contact with each other at a second common interface. Multi-shot injection molding technology can be used to produce the unified body that is the optical plate 20, with no gaps existing at the first or second common interfaces. The first transparent layer 21 defines a plurality of conical frustum protrusions 211 at an outer surface 210 that is distalmost from the second transparent layer 23. The second transparent layer 23 defines a plurality of spherical depressions 231 at an outer surface 230 that is distalmost from the first transparent layer 21. In the illustrated embodiment, the spherical depressions 231 are hemispherical. In alternative embodiments, the spherical depressions 231 can be sub-hemispherical.

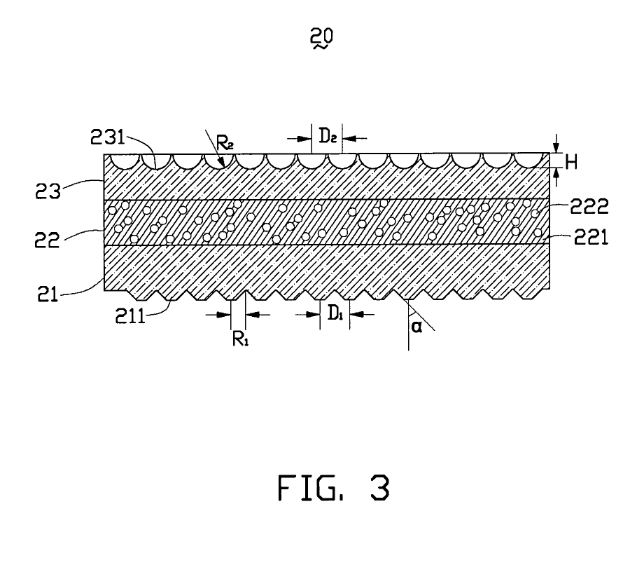

Further referring to FIG. 3, to achieve high quality optical effects, a pitch D₁ between adjacent conical frustum protrusions 211 on the first transparent layer 21 is preferably in a range from about 0.025 millimeters to about 1.5 millimeters. A maximum radius R₁ of each conical frustum protrusion 211 is configured to be in the following range: D₁/4≦R₁≦D₁/2. An angle α of a side surface of each conical frustum protrusion 211 relative to an axis of the conical frustum protrusion 211 is preferably in a range from about 30 degrees to about 75 degrees. On the second transparent layer 23, a pitch D₂ between centers of adjacent spherical depressions 231 is preferably in a range from about 0.025 millimeters to about 1.5 millimeters. A radius R₂ of each spherical depression 231 is configured to be in the following range: D₂/4≦R₂≦2D₂. A height H of each spherical depression 231 is configured to be in the following range: 0.01 millimeters≦H≦R₂.

The light diffusion layer 22 is configured for enhancing uniformity of light output from the optical plate 20. The light diffusion layer 22 includes a transparent matrix resin 221, and a plurality of diffusion particles 222 uniformly dispersed in the transparent matrix resin 221. The transparent matrix resin 221 is made of material selected from the group consisting of polyacrylic acid (PAA), polycarbonate (PC), polystyrene (PS), polymethyl methacrylate (PMMA), methyl methacrylate and styrene copolymer (MS), and any suitable combination thereof. The diffusion particles 222 can be made of material selected from the group consisting of titanium dioxide, silicon dioxide, acrylic resin, and any combination thereof. The diffusion particles 222 are configured for scattering light and enhancing the light distribution capability of the light diffusion layer 22. The light diffusion layer 22 preferably has a light transmission ratio in a range from 30% to 98%. The light transmission ratio of the light diffusion layer 22 is determined by a composition of the transparent matrix resin 221 and the diffusion particles 222.

A thickness of the first transparent layer 21, the light diffusion layer 22, and the second transparent layer 23 can each be greater than or equal to about 0.35 millimeters. In a preferred embodiment, a combined thickness of the first transparent layer 21, the light diffusion layer 22, and the second transparent layer 23 is in a range from about 1.05 millimeters to about 6 millimeters. The first transparent layer 21 and the second transparent layer 23 can each be made of material selected from the group consisting of polyacrylic acid (PAA), polycarbonate (PC), polystyrene (PS), polymethyl methacrylate (PMMA), methyl methacrylate and styrene copolymer (MS), and any suitable combination thereof. It should be pointed out that materials of the first and second transparent layers 21, 23 can either be the same or different.

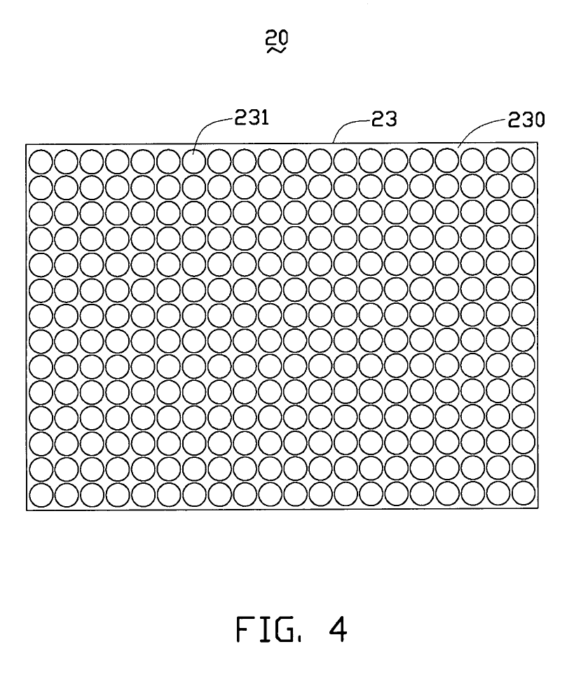

Further referring to FIG. 4, in the illustrated embodiment, the spherical depressions 231 are arranged in a regular m×n type matrix at the outer surface 230 of the second transparent layer 23. The spherical depressions 231 are spaced slightly apart from one another. Referring also to FIG. 1, in the illustrated embodiment, the conical frustum protrusions 211 are arranged in a regular m×n type matrix at the outer surface 210 of the first transparent layer 21.

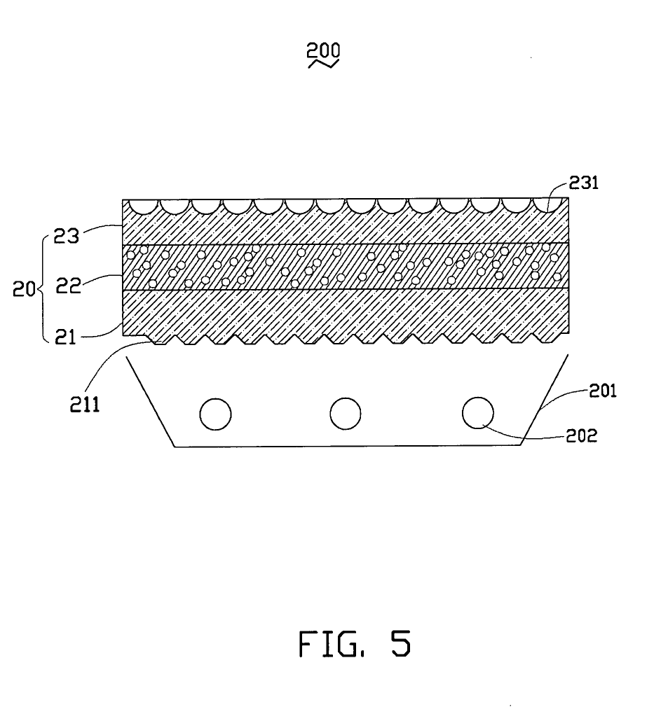

Referring to FIG. 5, a direct type backlight module 200 according to a second embodiment of the present invention is shown. The backlight module 200 includes a housing 201, a plurality of lamp tubes 202, and the optical plate 20. The lamp tubes 202 are regularly arranged above a base of the housing 201. The optical plate 20 is positioned on top of the housing 201, with the first transparent layer 21 facing the lamp tubes 202. It should be pointed out that in an alternative embodiment, the optical plate 20 could be arranged so that the second transparent layer 23 faces the lamp tubes 202. That is, light from the lamp tubes 202 can enter the optical plate 20 via either the first transparent layer 21 or the second transparent layer 23 as selected.

In the backlight module 200, when light enters the optical plate 20 via the first transparent layer 21, the light is first diffused by the conical frustum protrusions 211 of the first transparent layer 21. The diffused light is then further substantially diffused by the light diffusion layer 22 of the optical plate 20. Finally, the diffused light is concentrated by the spherical depressions 231 of the second transparent layer 23 before exiting the optical plate 20. Therefore, a brightness of the backlight module 200 is increased. In addition, the light is diffused at two levels, so that a uniformity of the light output from the optical plate 20 is enhanced. Furthermore, the first transparent layer 21, the light diffusion layer 22, and the second transparent layer 23 are integrally formed together (see above), with no air or gas pockets trapped in the respective first and second common interfaces. Thus there is little or no back reflection at the common interfaces, and an efficiency of utilization of light is increased. Moreover, when the optical plate 20 is utilized in the backlight module 200, the optical plate 20 in effect replaces a conventional combination of a diffusion plate and a prism sheet. Thereby, a process of assembly of the backlight module 200 is simplified, and an efficiency of assembly is improved. Still further, in general, a volume occupied by the optical plate 20 is less than that occupied by the conventional combination of a diffusion plate and a prism sheet. Thereby, a volume of the backlight module 200 is reduced.

In the alternative embodiment, when light enters the optical plate 20 via the second transparent layer 23, the uniformity of light output from the optical plate 20 is also enhanced, and an efficiency of utilization of the light is also increased. Nevertheless, the light emitted from the optical plate 20 via the first transparent layer 21 is different from the light emitted from the optical plate 20 via the second transparent layer 23. For example, when light enters the optical plate 20 via the first transparent layer 21, a viewing angle of the backlight module 200 is somewhat greater than that of the backlight module 200 when light enters the optical plate 20 via the second transparent layer 23.

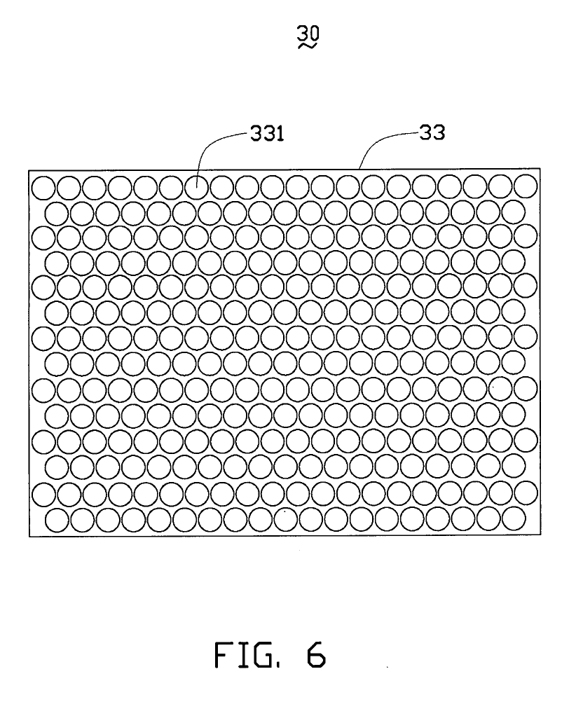

Referring to FIG. 6, an optical plate 30 according to a third embodiment of the present invention is shown. The optical plate 30 is similar in principle to the optical plate 20 of the first embodiment. The optical plate 30 includes a second transparent layer 33 and a plurality of spherical depressions 331 arranged in rows. Adjacent spherical depressions 331 in each row are spaced apart from each other. The spherical depressions 331 in any two adjacent rows are staggered relative to each other. All the spherical depressions 331 in any one row are spaced apart from all the spherical depressions 331 in each of the adjacent rows. Thus a matrix comprised of offset rows of the spherical depressions 331 is formed.

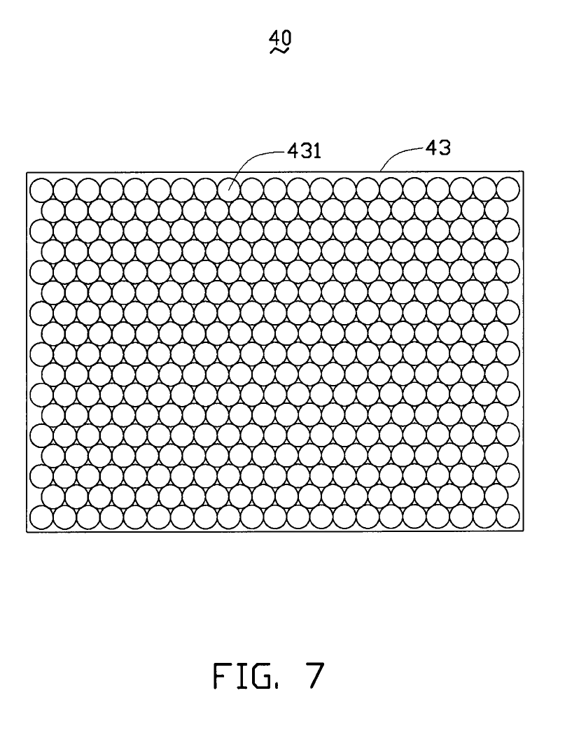

Referring to FIG. 7, an optical plate 40 according to a fourth embodiment of the present invention is shown. The optical plate 40 is similar in principle to the optical plate 30 of the third embodiment. The optical plate 40 includes a second transparent layer 43, and a plurality of spherical depressions 431 arranged in rows. Adjacent spherical depressions 431 in each row adjoin each other. The spherical depressions 431 in any two adjacent rows are staggered relative to each other and abut each other. Thus a matrix comprised of offset rows of the spherical depressions 431 is formed. Considered another way, a honeycomb pattern of the spherical depressions 431 is formed.

In each of the above-described optical plates 20, 30, and 40, a first common interface between the light diffusion layer and the first transparent layer is flat. Similarly, a second common interface between the light diffusion layer and the second transparent layer is flat. In one kind of alternative embodiment, the first common interface between the light diffusion layer and the first transparent layer can be nonplanar. One example of this kind of configuration is given below.

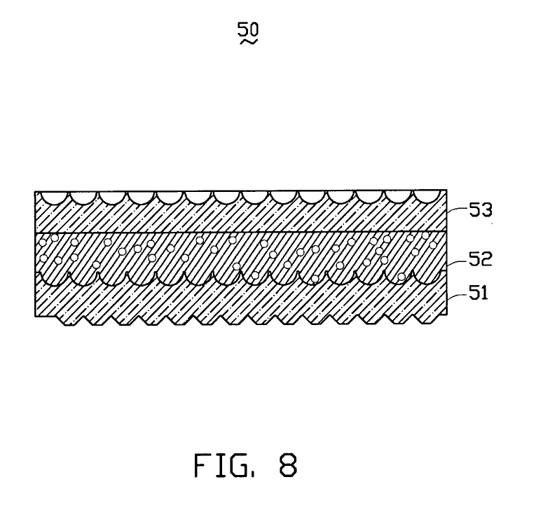

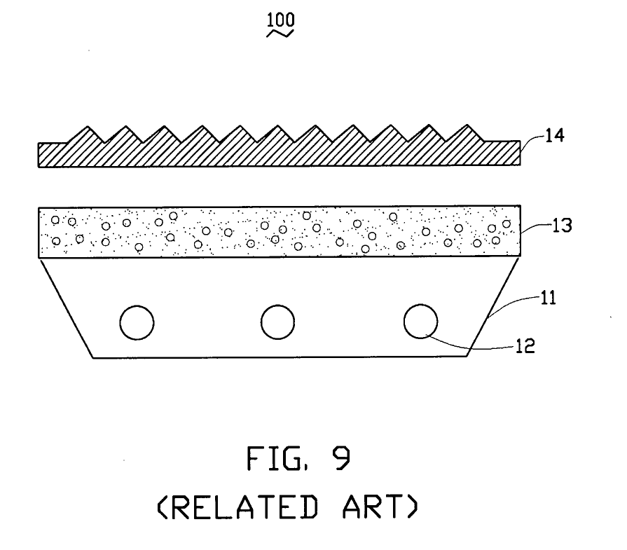

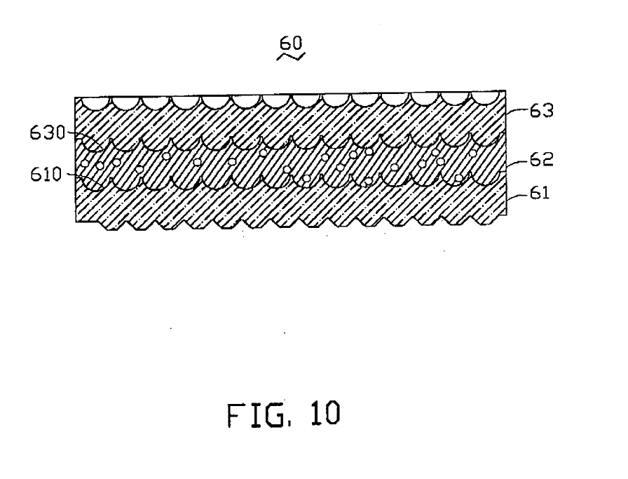

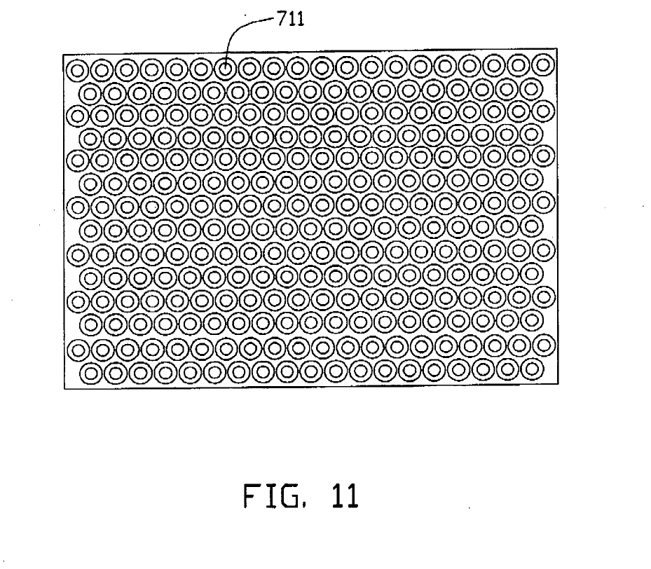

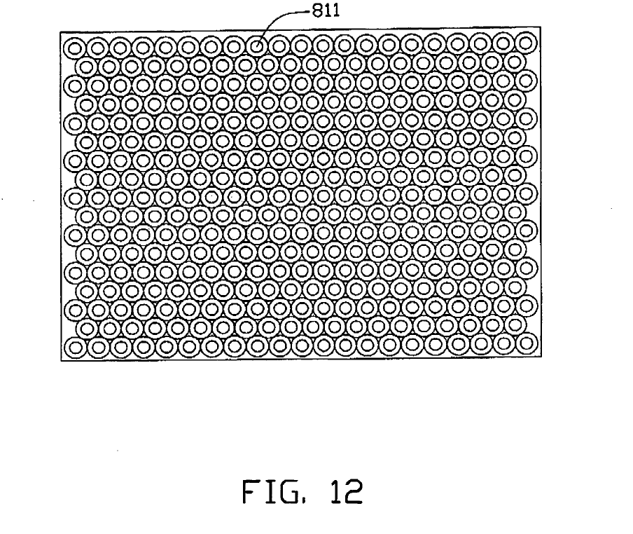

Referring to FIG. 8, an optical plate 50 according to a fifth embodiment of the present invention is shown. The optical plate 50 is similar in principle to the optical plate 20 of the first embodiment. The optical plate 50 includes a first transparent layer 51, a light diffusion layer 52, and a second transparent layer 53. A first common interface (not labeled) between the first transparent layer 51 and the light diffusion layer 52 is a knobbly kind of interface. In the illustrated embodiment, the first common interface can be considered to be defined by a plurality of protrusions of the light diffusion layer 52 interlocked in a corresponding plurality of depressions of the first transparent layer 51. Therefore an area of mechanical engagement between the first transparent layer 51 and the light diffusion layer 52 is increased, and a binding strength between the first transparent layer 51 and the light diffusion layer 52 can be enhanced.

Further embodiments of the optical plate and backlight module using the optical plate can include the following. For example, any one of the optical plates 30, 40, 50 can substitute the optical plate 20 used in the backlight module 200. The conical frustum protrusions can be arranged at the outer surface of the first transparent layer in a manner that is the same as, similar to, or differs from the arrangement of the spherical depressions at the outer surface of the second transparent layer.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. An optical plate, comprising:
a first transparent layer;
a second transparent layer; and
a light diffusion layer between the first transparent layer and the second transparent layer, the light diffusion layer comprising a transparent matrix resin and a plurality of diffusion particles dispersed in the transparent matrix resin, wherein the first transparent layer, the light diffusion layer, and the second transparent layer are integrally molded together, with the first transparent layer in immediate contact with the light diffusion layer and the second transparent layer in immediate contact with the light diffusion layer such that there are no air or gas pockets trapped between the first transparent layer and the light diffusion layer nor between the second transparent layer and the light diffusion layer, and the first transparent layer comprises a plurality of conical frustum protrusions at an outer surface thereof that is farthest from the second transparent layer, and the second transparent layer comprises a plurality of spherical depressions at an outer surface thereof that is farthest from the first transparent layer.

2. The optical plate as claimed in claim 1, wherein a thickness of each of the light diffusion layer, the first transparent layer, and the second transparent layer is greater than or equal to about 0.35 millimeters.

3. The optical plate as claimed in claim 2, wherein a combined thickness of the light diffusion layer, the first transparent layer and second transparent layer is in the range from about 1.05 millimeters to about 6 millimeters.

4. The optical plate as claimed in claim 1, wherein each of the first transparent layer and the second transparent layer is made of material selected from the group consisting of polyacrylic acid, polycarbonate, polystyrene, polymethyl methacrylate, methyl methacrylate and styrene copolymer, and any combination thereof.

5. The optical plate as claimed in claim 1, wherein an angle defined by a side surface of each conical frustum protrusion relative to an axis of the conical frustum protrusion is in the range from about 30 degrees to about 75 degrees.

6. The optical plate as claimed in claim 1, wherein at least one of the following pitches is in the range from about 0.025 millimeters to about 1.5 millimeters: a pitch between centers of adjacent conical frustum protrusions, and a pitch between centers of adjacent spherical depressions.

7. The optical plate as claimed in claim 1, wherein the transparent matrix resin of the light diffusion layer is made of material selected from the group consisting of polyacrylic acid, polycarbonate, polystyrene, polymethyl methacrylate, methyl methacrylate and styrene copolymer, and any combination thereof.

8. The optical plate as claimed in claim 1, wherein a material of the diffusion particles is selected from the group consisting of titanium dioxide, silicon dioxide, acrylic resin, and any combination thereof

9. The optical plate as claimed in claim 1, wherein at least one of the following groups of elements is arranged in a regular m×n matrix; the plurality of conical frustum protrusions, and the plurality of spherical depressions.

10. The optical plate as claimed in claim 1, wherein the spherical depressions are arranged at the outer surface of the second transparent layer in rows, adjacent conical spherical depressions in any one row are separate from each other, the spherical depressions in any one row are staggered relative to the spherical depressions in each of the adjacent rows, and the spherical depressions in any one row are spaced apart from all the spherical depressions in each of the adjacent rows.

11. The optical plate as claimed in claim 1, wherein the spherical depressions are arranged at the outer surface of the second transparent layer in rows, adjacent spherical depressions in any one row adjoin each other, the spherical depressions in any one row are staggered relative to the spherical depressions in each of the adjacent rows, and each of the spherical depressions in any one row adjoin two corresponding spherical depressions in each of the adjacent rows.

12. The optical plate as claimed in claim 1, wherein the conical frustum protrusions are arranged at the outer surface of the first transparent layer in rows, adjacent conical frustum protrusions in any one row are separate from each other, the conical frustum protrusions in any one row are staggered relative to the conical frustum protrusions in each of the adjacent rows, and the conical frustum protrusions in any one row are separate from all the conical frustum protrusions in each of the adjacent rows.

13. The optical plate as claimed in claim 1, wherein the conical frustum protrusions are arranged at the outer surface of the first transparent layer in rows, adjacent conical frustum protrusions in any one row adjoin each other, the conical frustum protrusions in any one row are staggered relative to the conical frustum protrusions in each of the adjacent rows, and each of the conical frustum protrusions in any one row adjoin two corresponding conical frustum protrusions in each of the adjacent rows.

14. The optical plate as claimed in claim 1, wherein at least one of the following interfaces is flat: an interface between the light diffusion layer and the first transparent layer, and an interface between the light diffusion layer and the second transparent layer.

15. The optical plate as claimed in claim 1, wherein at least one of the following interfaces is nonplanar: an interface between the light diffusion layer and the first transparent layer, and an interface between the light diffusion layer and the second transparent layer.

16. The optical plate as claimed in claim 1, wherein the nonplanar interface between the light diffusion layer and the first transparent layer is defined by a plurality of protrusions of one of the light diffusion layer and the first transparent layer interlocked in a corresponding plurality of depressions of the other of the light diffusion layer and the first transparent layer, and the nonplanar interface between the light diffusion layer and the second transparent layer is defined by a plurality of protrusions of one of the light diffusion layer and the second transparent layer interlocked in a corresponding plurality of depressions of the other of the light diffusion layer and the second transparent layer.

17. A direct type backlight module, comprising:
a housing;
a plurality of light sources disposed on or above a base of the housing; and
an optical plate disposed above the light sources at a top of the housing, the optical plate comprising:
a first transparent layer;
a second transparent layer; and
a light diffusion layer between the first transparent layer and the second transparent layer, the light diffusion layer comprising a transparent matrix resin and a plurality of diffusion particles dispersed in the transparent matrix resin, wherein the first transparent layer, the light diffusion layer, and the second transparent layer are integrally molded together, with the first transparent layer in immediate contact with the light diffusion layer and the second transparent layer in immediate contact with the light diffusion layer such that there are no air or gas pockets trapped between the first transparent layer and the light diffusion layer nor between the second transparent layer and the light diffusion layer, and the first transparent layer comprises a plurality of conical frustum protrusions at an outer surface thereof that is farthest from the second transparent layer, and the second transparent layer comprises a plurality of spherical depressions at an outer surface thereof that is farthest from the first transparent layer.

18. The direct type backlight module as claimed in claim 17, wherein a selected one of the first transparent layer and the second transparent layer of the optical plate is arranged to face the light sources.
